(19) United States
(12) Patent Application Publication
(10) Pub. No.: US 2026/0270643 A1
(43) Pub. Date: Sep. 10, 2026

(54) SEAT-DEPENDENT AUDIO DUCKING

(71) Applicant: Analog Devices International Unlimited Company, Limerick (IE)

(72) Inventor: Vicent Moles Cases, Valencia (ES)

(21) Appl. No.: 19/179,947

(22) Filed: Apr. 15, 2025

Related U.S. Application Data
(60) Provisional application No. 63/767,291, filed on Mar. 5, 2025.

(51) Int. Cl. H04S 7/00; H04B 7/0452; H04S 3/00

(52) U.S. Cl. CPC H04S 7/307; H04B 7/0452; H04S 3/008; H04S 2400/01; H04S 2420/07

(57) ABSTRACT

Example implementations include methods, apparatuses, and systems for receiving one or more audio channels by an audio ducking system of an audio system; splitting each audio channel of the one or more audio channels into a plurality of frequency subband channels corresponding to a plurality of frequency subbands; performing Multiple Input Multiple Output (MIMO)—based audio ducking on first ones of the plurality of frequency subband channels that correspond to a first subset of the plurality of frequency subbands that are below a frequency threshold; and skipping the MIMO-based audio ducking on second ones of the plurality of frequency subband channels that correspond to a second subset of the plurality of frequency subbands that are equal to or above the frequency threshold.

### CROSS-REFERENCE TO RELATED APPLICATIONS

This application claims priority to U.S. Provisional Application Ser. No. 63/767,291, entitled “SEAT-DEPENDENT AUDIO DUCKING FOR VEHICLES” and filed on Mar. 5, 2025, which is incorporated by reference herein in the entirety.

### FIELD

The present disclosure relates generally to sound systems, and more specifically, to audio ducking in a sound system.

### BACKGROUND

A sound system of a vehicle typically has the following workflow: (A) an audio program selected by the passengers (e.g., the audio program which the passengers want to listen to) is fed to the sound system; (B) the audio program is pre-processed using signal processing to achieve certain effects such as upmixing, equalization, room correction, etc.; and (C) the processed audio at the output of the signal processing stage is fed to the speakers of the sound system. In some cases, the audio program that is being played from a sound system may need to be ducked, that is, the playback volume for the audio program may need to be decreased for a certain amount of time. For example, when another audio signal, such as a navigation prompt, needs to be delivered to the passengers of a vehicle, the audio program that is being played is ducked during the navigation prompt reproduction, such that the passengers can clearly listen to the navigation prompt and are not disturbed/distracted by the audio program.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method comprising receiving one or more audio channels by an audio ducking system of an audio system. The method further includes splitting each audio channel of the one or more audio channels into a plurality of frequency subband channels corresponding to a plurality of frequency subbands. The method further includes performing Multiple Input Multiple Output (MIMO)—based audio ducking on first ones of the plurality of frequency subband channels that correspond to a first subset of the plurality of frequency subbands that are below a frequency threshold. The method further includes skipping the MIMO-based audio ducking on second ones of the plurality of frequency subband channels that correspond to a second subset of the plurality of frequency subbands that are equal to or above the frequency threshold.

Another example aspect includes a system comprising an audio ducking system of an audio system. The system comprises one or more band splitters configured to split each audio channel of one or more audio channels into a plurality of frequency subband channels corresponding to a plurality of frequency subbands. The system further comprises one or more MIMO-based audio ducking components configured to perform MIMO-based audio ducking on first ones of the plurality of frequency subband channels that correspond to a first subset of the plurality of frequency subbands that are below a frequency threshold, wherein the system is configured to skip MIMO-based audio ducking on second ones of the plurality of frequency subband channels that correspond to a second subset of the plurality of frequency subbands that are equal to or above the frequency threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 is a block diagram of an example Multiple Input Multiple Output (MIMO) processing system, according to some aspects of the present disclosure;

FIG. 2 is a block diagram of an example MIMO processing system that provides multiple sound zones in an acoustic space, according to some aspects of the present disclosure;

FIG. 3 is a block diagram of the example MIMO processing system of FIG. 2 providing two sound zones in an acoustic space, according to some aspects of the present disclosure;

FIG. 4 is a block diagram of an example subband MIMO processing system, according to some aspects of the present disclosure;

FIG. 5 is a block diagram of a first example sound system, according to some aspects of the present disclosure;

FIG. 6 is a block diagram of an example demultiplexer in the first example sound system of FIG. 5, according to some aspects of the present disclosure;

FIG. 7 is a block diagram of a second example sound system, according to some aspects of the present disclosure;

FIG. 8 is a block diagram of a third example sound system, according to some aspects of the present disclosure;

FIG. 9 is a block diagram of a fourth example sound system, according to some aspects of the present disclosure;

FIG. 10 is a block diagram of an example restricted MIMO block in the fourth example sound system of FIG. 9, according to some aspects of the present disclosure;

FIG. 11 is a block diagram of an example sound system performance evaluation system, according to some aspects of the present disclosure;

FIG. 12 is a schematic diagram of a first example vehicle speaker layout, according to some aspects of the present disclosure;

FIG. 13 is a schematic diagram of a second example vehicle speaker layout, according to some aspects of the present disclosure;

FIG. 14 is a schematic diagram of a third example vehicle speaker layout, according to some aspects of the present disclosure;

FIG. 15 is a block diagram of an example computing device that may implement all or a portion of any component or functionality in FIGS. 1-14 and/or in FIG. 16, according to some aspects of the present disclosure; and

FIG. 16 is a flowchart of an example audio ducking method, according to some aspects of the present disclosure, where dashed lines indicate option actions.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure provide audio ducking in a sound system by implementing Multiple Input Multiple Output (MIMO)—based audio ducking only in frequencies in which MIMO-based audio ducking can achieve sufficient ducking levels and sufficient sound quality, while skipping MIMO-based audio ducking in frequencies in which MIMO-based audio ducking would otherwise degrade sound quality and cannot provide sufficient ducking levels. Although some present aspects are described herein with reference to an audio system of a vehicle, the present aspects are not so limited and are applicable for audio ducking in other sound systems, such as a sound system in any space such as a room, a theatre, etc.

Generally, passengers of a vehicle may be provided with personalized cabin experiences, which may include personalized audio experiences such as different users of the vehicle listening to different audio programs or listening to the same audio program but with different settings (e.g., with different playback volumes or equalizations for each passenger). In some cases, the personalization may further include ducking of the audio program played by the sound system only in certain seats of a vehicle rather than in the entire cabin, e.g., decreasing the playback volume of the audio program only in a subset of one or more seats while for the other seats the playback volume is not reduced. For example, the audio program may be ducked only in the driver seat when a navigation prompt is delivered to the driver, while the other passengers in the vehicle do not perceive the ducking and are not annoyed by the change in the playback volume. As another example, the audio program may be ducked in a subset of seats in which the passengers want to rest and do not want to be disturbed, while the other passengers can listen to the audio program with a higher playback volume. Further examples include, but are not limited to, ducking the program to play a notification, an instruction, or an audio conversation. For example, the audio program may be ducked to play a ring tone of an incoming phone call, a phone call audio signal, a vehicle notification message (e.g., oil/gas/tire pressure is low, engine warning, etc.), an audio signal from another device (a person's cell phone or another vehicle component), etc.

In some cases, scalar-based audio ducking may be used for ducking the audio program played by a sound system. In scalar-based ducking, the audio program is ducked by decreasing the gain of the input audio program. Therefore, in a vehicle sound system that implements scalar-based ducking, the audio program is ducked in all seats of the vehicle, and therefore scalar-based audio ducking cannot provide personalized ducking to passengers of the vehicle.

In some alternative cases, Multiple Input Multiple Output (MIMO)—based audio ducking may be used for ducking the audio program played by a sound system. In MIMO-based ducking, MIMO processing is implemented together with an array of speakers to achieve control over the sound field in different seats. For example, in order to achieve ducking only in a certain subset of seats, the MIMO processing is configured such that destructive interferences are created in the seats in which audio is to be ducked, and constructive interferences are created in the other seats. Such ducking may be referred to as Personal Sound Zones (PSZ), Personal Audio, Individual Listening Zones, Audio Bubbles, etc.

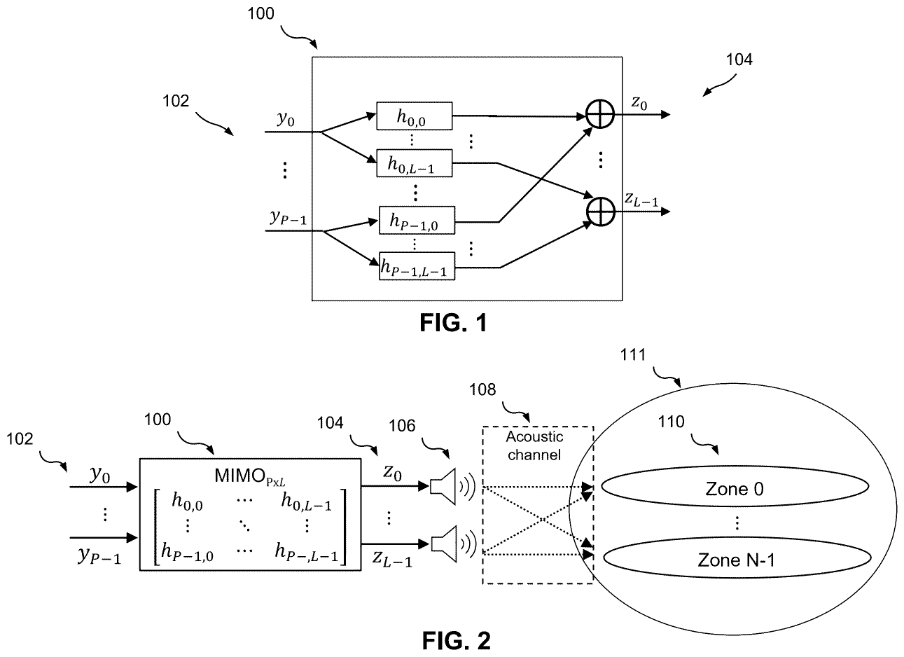

Referring to FIG. 1, an example MIMO processing system 100 takes P≥1 input signals 102 and processes them to obtain L≥1 output signals 104, where yₚ is the p-th input signal, zₗ is the l-th output signal, and h_{p,l} is the signal processing block applied to the p-th input signal to obtain its contribution to the l-th output signal. In various aspects, each h_{p,l} in the MIMO processing system 100 may be a gain factor, a Finite Impulse Response (FIR), or an Infinite Impulse Response (IIR) filter, but other types of processing may also be used, such as non-linear filtering.

Referring to FIG. 2, the MIMO processing system 100 may be used together with an array of L speakers 106 to control the sound field in multiple sound zones 110 of an acoustic space 111. Such MIMO processing may be used to render different audio programs to the multiple sound zones 110, to render the same audio program with different playback volumes in the multiple sound zones 110, etc. Specifically, for example, each input signal yₚ is processed and mapped to all the output signals zₗ, which are then played from the speakers 106. The output signals zₗ played from the speakers 106 go through an acoustic channel 108 which combines the contributions of all the speakers 106 to obtain the sound field in the sound zones 110 of the acoustic space 111. Therefore, the sound field generated in each sound zone is a superposition of the sound fields generated by each individual speaker. Since every input yₚ is processed and mapped to every speaker, the processing blocks h_{p,y} of the MIMO processing system 100 can be configured such that the combination of the sound fields created by the individual speakers leads to a certain desired sound field in each sound zone.

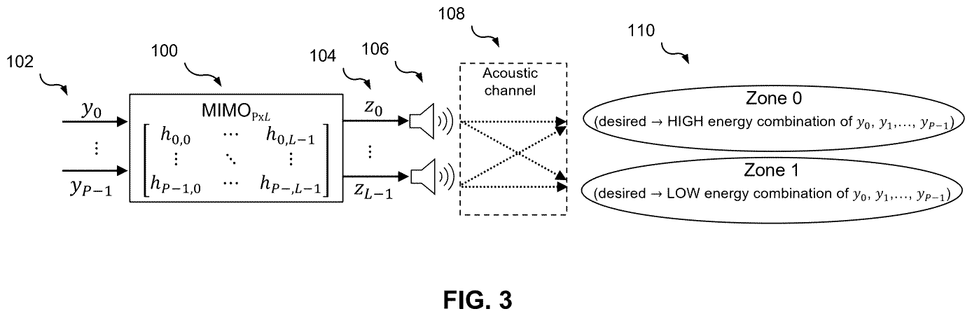

MIMO processing may have different applications according to the selected input signals. For example, referring to FIG. 3, the MIMO processing system 100 may be configured to render a multi-channel audio program with different playback volumes in two different sound zones 110 of a vehicle. Accordingly, personalized audio ducking may be obtained, for example, by reducing the volume in which the audio program is played only in certain seats of the vehicle that are in sound zone 1, while all seats in sound zone 0 and sound zone 1 get the same audio content.

In MIMO-based audio ducking in a vehicle, the frequency range in which sufficient control of the sound field is achieved is affected by the distance between the speakers of the audio system of the vehicle (due to spatial aliasing) and by the acoustics of the vehicle. As such, MIMO-based audio ducking in a vehicle may not obtain desired levels of ducking at high frequencies since the distance between the speakers in vehicles is typically much larger than the wavelength of the sound. Moreover, insufficient ducking levels that are achieved at high frequencies are obtained at the cost of significantly worsening the audio quality that is provided to the passengers. Therefore, MIMO-based audio ducking in a vehicle leads to a system in which no significant ducking is achieved at high frequencies while the audio quality of the high frequencies is also worsened.

In some aspects, “sufficient” audio quality is said to be achieved in a vehicle when the audio perceived by the passengers of the vehicle keeps the properties of the input audio program in terms of balance, spatiality, and diffuseness. For example, for an input audio program that has 5.1 channels, “sufficient” audio quality is considered to be achieved if the passengers can perceive three front channels (e.g., left, right, and center), two surround channels (e.g., left and right) and one Low Frequency Effect (LFE) channel, and when these channels have levels of balance and diffuseness similar to the original input audio program. However, the audio quality is said to be “insufficient” if the passengers of the vehicle perceive the different audio channels as not arriving from the positions originally designed (e.g., three front channels, two surround channels, and one LFE), and/or if the balance or diffuseness of the perceived audio differs significantly from the ones in the original audio program.

In summary, MIMO-based audio ducking can provide personalized ducking but with poor performance at high frequencies. Specifically, for example, personalized ducking with MIMO processing is not desirable in frequency regions in which MIMO processing cannot provide large ducking levels and sufficient audio quality, since it is not worthwhile to significantly worsen the audio quality to obtain small ducking levels. For example, a 1 dB ducking in the frequency range 5 kHz to 10 kHz is almost impossible to perceive by the human ear, but a small worsening of the audio quality can be easily perceived by the human ear.

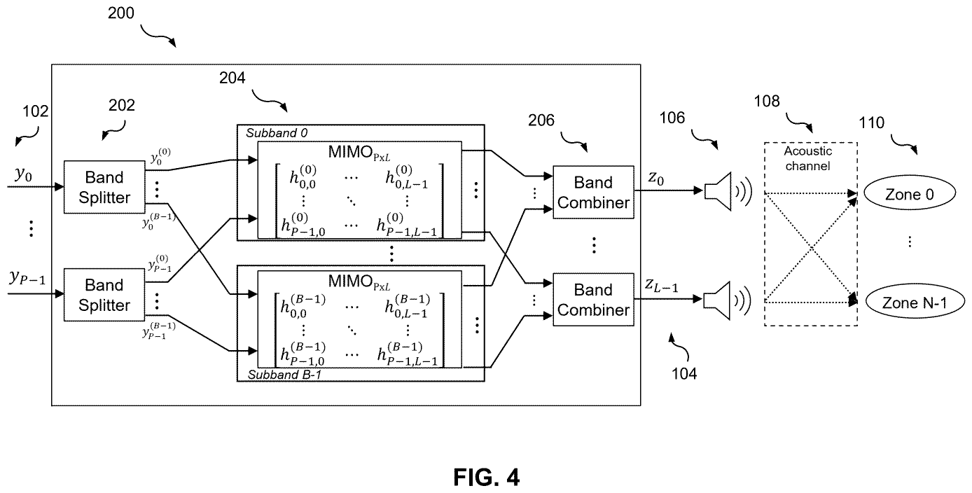

Referring to FIG. 4, a subband MIMO processing system 200 provides a variation of MIMO processing that may be used to control the sound field in multiple sound zones 110,

where each input 102 of the system yₚ is split into B subband components

$${y}_{p}^{( b )}$$

using a band splitter 202; the signals

$${y}_{p}^{( b )}$$

are processed using different MIMO blocks 204 in each subband, where

$${h}_{p , l}^{( b )}$$

is the signal processing block applied to the p-th input signal in the b-th subband to obtain its contribution to the l-th output signal in the b-th subband; and the processed signals in all subbands are fed to band combiners 206 to obtain the L broadband signals zₗ that are fed to the speakers 106.

In some aspects, the band splitters 202 and the band combiners 206 may be implemented in multiple ways, for example, using FIR or IIR band pass filters. Moreover, the band splitters 202 and the band combiners 206 may decimate or interpolate the signals in certain subbands if needed.

An advantage of subband MIMO processing is that different configurations may be used for the MIMO blocks 204 in each subband. For example, if the blocks

$${h}_{l , p}^{( b )}$$

are FIR filters, different filter lengths may be used in different subbands. This is useful in reducing the Digital Signal Processing (DSP) resource consumptions, since typically shorter filter lengths can be selected for the higher frequency subbands while longer filters are used for the lower frequency subbands.

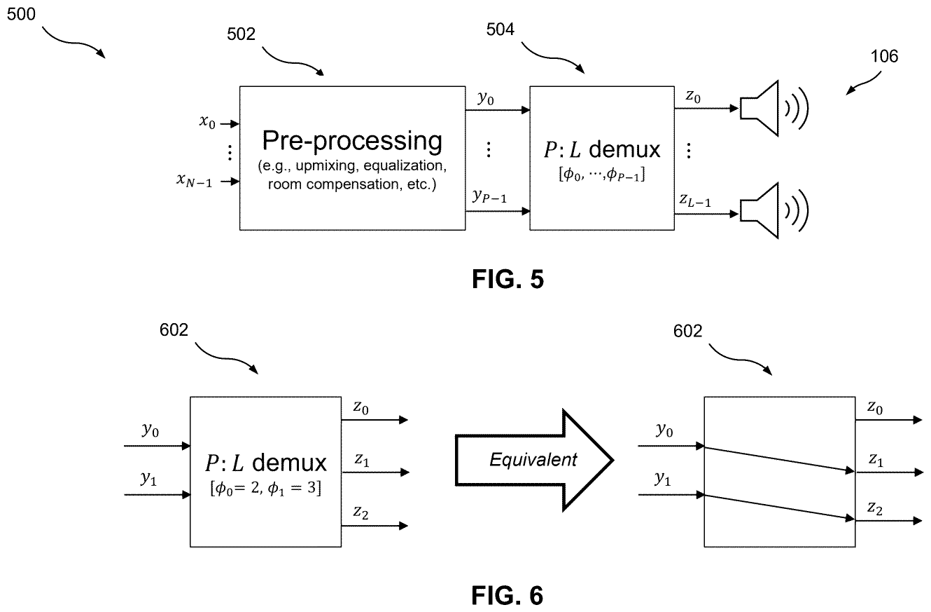

Referring to FIG. 5, a block diagram of a first example sound system 500 using L speakers 106 is provided, where xₙ is the n-th channel of the input audio program selected by a user (e.g., N=1 for mono input, N=2 for stereo input, etc.); the input audio program is fed to a pre-processing block 502 which modifies and combines the N inputs xₙ to obtain P outputs yₚ (e.g., according to various selected features, such as upmixing, equalization, room compensation, etc.), where N and P may be different; and the outputs yₚ of the pre-processing block 502 are fed to a P: L demultiplexer 504 which maps each input yₚ to one output zₗ(L≥P). In these aspect, multiple inputs yₚ are not mapped to the same output zₚ. This ensures that the audios output by different speakers 106 do not interfere with each other and/or cancel one another.

It should be noted that the block diagram in FIG. 5 is a simplification in which certain elements, such as Analog to Digital Converters (ADCs), Digital to Analog Converters (DACs), and/or power amplifiers are omitted for the sake of simplicity. It should be noted that the pre-processing block 502 is not related to ducking of the audio program, and that the present aspects are not limited to any particular pre-processing block 502. The pre-processing block 502 is provided to give a more complete overview of the different building blocks of a sound system, such as a sound system of a vehicle.

The P:L demultiplexer 504 in FIG. 5 is configured to take P≥1 inputs yₚ and map them to L≥1 outputs z_{φ}_{ₚ} (with L≥P), where φₚ indicates to which output the p-th input is mapped:

$${z}_{{ϕ}_{p}} = {y}_{p} ,$$

and each input yₚ is only mapped to one output zₚ, and multiple inputs yₚ are not mapped to the same output zₚ. An example of a 2:3 demultiplexer 602 is provided in FIG. 6, where P=2, L=3, φ₀=1, and φ₁=2 (i.e., input 0 is mapped to output 1, input 1 to output 2, and output 0 is not populated).

In one non-limiting aspect, for example, for a stereo input audio program (i.e., N=2), P=6 outputs for the pre-processing block 502, and L=6 speakers 106, the pre-processing block 502 applies upmixing to the 2-channels input audio program to obtain P=6 signals, and the P: L demultiplexer 504 maps each of the outputs of the pre-processing block 502 to one of the speakers 106 of the system 500.

It should be noted that in some alternative aspects, the P:L demultiplexer 504 may be integrated in the pre-processing block 502, in which case the pre-processing block 502 will have L outputs instead of P outputs.

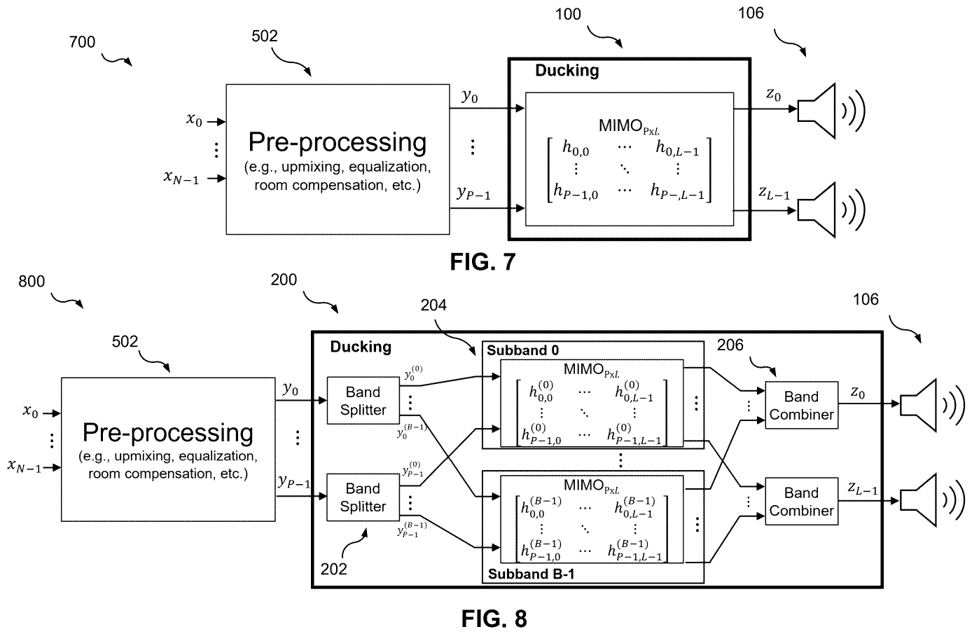

Referring to FIG. 7, a second example sound system 700 may implement MIMO-based ducking (e.g., PSZ) using the MIMO processing system 100, where the number of outputs P of the pre-processing block 502 and the number of speakers L 106 may be different so long as they fulfil L≥P. Using more speakers than input signals may be useful, for example, for achieving additional cancelation of the signals in certain seats of a vehicle. The processing blocks h_{p,l} of the MIMO processing system 100 may be selected as follows. When ducking is not desired, the values of h_{p,l} are selected such that similar levels of playback volume are obtained in all seats of the vehicle. When ducking is desired, the values of h_{p,l} are selected such that lower playback volume is achieved in a subset of seats while the playback volume and the audio quality remains the same in the other seats. The values for h_{p,l} for different ducking scenarios may be computed online, for example, using the information obtained from an error microphone, or may be computed offline, for example, using the information obtained from an offline tuning of the vehicle cabin.

Such MIMO-based ducking may obtain large levels of ducking of the audio program for a subset of seats without ducking in the other seats at low and medium frequencies, and provides sufficient audio quality for low and medium frequencies. However, MIMO-based ducking does not obtain large levels of ducking at high frequencies due to the spatial aliasing effect. Further, the small ducking levels at high frequencies are obtained at the expense of significantly worsening the audio quality at high frequencies. That is, MIMO-based ducking does not provide significant ducking for the higher frequencies, and produces a serious degradation of the audio quality. Further, MIMO-based ducking uses DSP resources to apply the MIMO processing at high frequencies in which no significant ducking and poor audio quality are obtained.

Referring to FIG. 8, a third example sound system 800 may implement subband MIMO-based ducking using the subband MIMO processing system 200. An advantage of the third example sound system 800 as compared to the second example sound system 700 is that different MIMO systems with different configurations can be used in different subbands in the third example sound system 800. For example, in cases where MIMO processing in the subband MIMO processing system 200 is implemented using FIR filtering, different filter lengths can be used in different subbands. However, in the third example sound system 800, using MIMO processing that targets cancellation (e.g., control of the sound field) in all the subbands leads to a system that can provide neither sufficient levels of ducking nor sufficient audio quality at high frequencies. Therefore, subband MIMO-based ducking presents the same limitations in terms of performance as the broadband MIMO-based ducking.

In summary, the subband MIMO-based approach can reduce the DSP resource consumption, obtain large levels of ducking of the audio program for a subset of seats/target sound zones in a vehicle without ducking in the other seats/target sound zones at low and medium frequencies, and provide good audio quality for low and medium frequencies. However, the subband MIMO-based approach does not obtain large levels of ducking at high frequencies due to the spatial aliasing effect. Further, the small ducking levels at high frequencies are obtained at the expense of significantly worsening the audio quality at high frequencies. Therefore, the subband MIMO-based approach does not achieve significant ducking for higher frequencies, and produces a serious degradation of the audio quality at these frequencies. Further, the subband MIMO-based approach still uses DSP resources to apply the MIMO processing at high frequencies while no significant ducking and poor audio quality are obtained.

In contrast, some aspects of the present disclosure use MIMO processing only for those frequency regions in which MIMO processing can obtain sufficient control over the sound field, e.g., in the frequencies in which sufficient ducking levels and sufficient audio quality can be obtained. In the other frequency regions, the present aspects do not duck the audio, that is, the system of the present disclosure plays the audio program as received at the output of the pre-processing block 502 in the other frequency regions and may also add a delay to account for the delay introduced in the MIMO processed frequency regions. Accordingly, the present aspects achieve large ducking levels in the frequency regions in which MIMO processing is used, and also achieve sufficient audio quality in the whole bandwidth of the sound system (since sufficient audio quality is achieved in the frequency regions in which MIMO processing is used, and sufficient audio quality is also achieved in the frequency regions in which no MIMO processing is used).

In some aspects, the frequency ranges in which MIMO processing can obtain sufficient control over the sound field in a vehicle (which depends on the distance between the speakers in the vehicle) typically matches well with the frequencies that have a bigger impact on the loudness perceived by the human ear (e.g., the highest sensitivity is located around 1~2 kHz). Accordingly, ducking the audio in those frequencies can provide a significant loudness decrease to a target user, even if the audio program is not ducked over the entire human hearing range. Further, poor audio quality at high frequencies is very noticeable by the human ear. Therefore, obtaining sufficient audio quality in high frequencies is very important, while the level of ducking at high frequencies is not so important because the level of loudness perceived by the human ear is more influenced by the level of loudness at medium frequencies. If sufficient ducking is achieved for low and medium frequencies, sufficient ducking will be perceived by the human ear even if higher frequencies are not ducked at all, because the frequency components that have more effect in the perceived loudness are attenuated. Accordingly, the present aspects apply ducking only in low and medium frequencies, thus achieving sufficient levels of personalized ducking and audio quality in low and medium frequencies while also maintaining the audio quality at high frequencies.

The present aspects can reduce (duck) the loudness of the audio program that is being played by a vehicle sound system in a subset of seats (e.g., one or more seats, each of which may be associated with a separate sound zone) while the passengers in the other seats (e.g., one or more seats, each of which may be associated with a separate sound zone) are provided with the audio program without loudness reduction (without ducking). Further, the audio program that is played in the different seats has sufficient audio quality and does not need to be limited to a single spatial channel (e.g., does not have to be mono). For example, the audio program that is played in the seats and can be ducked in some of the seats when desired may have as many spatial audio channels and audio objects as desired (e.g., 2.1, 5.1, 7.1, 11.1, Dolby Atmos, etc.).

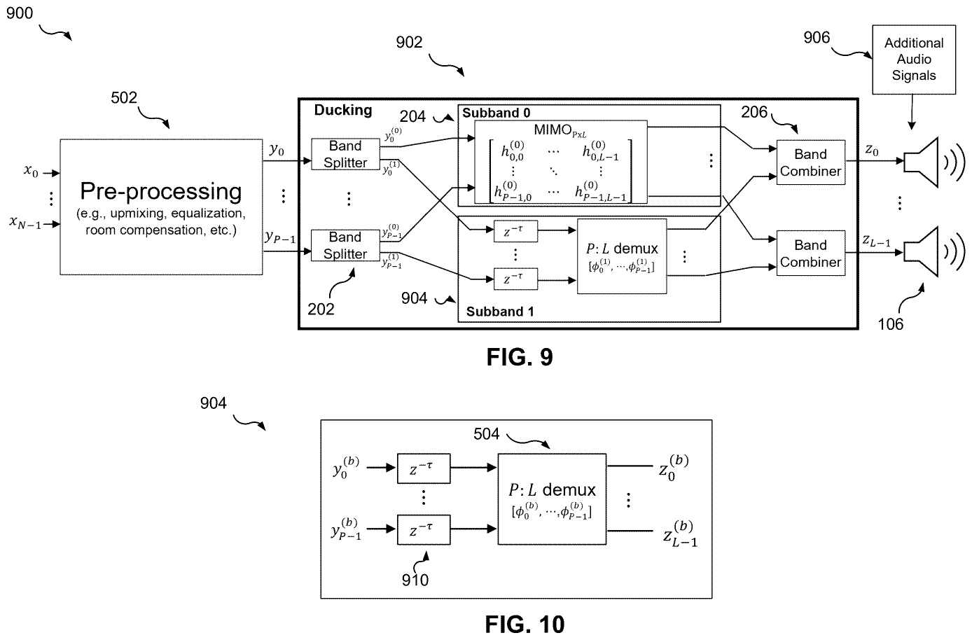

Referring to FIGS. 9 and 10, some present aspects provide a fourth example sound system 900 that implements a subband MIMO processing variation system 902 that uses the MIMO blocks 204 for subband MIMO processing for relatively low and medium frequencies, while imposing a restriction for relatively high frequencies such that ducking is not targeted in those frequencies. For example, in some aspects, the subband MIMO processing variation system 902 may implement restricted MIMO blocks 904 that apply the following restriction in subbands for which no ducking is targeted:

$${h}_{p , l}^{( b )} = \{ \begin{matrix}δ ( t - τ ) & if l = {ϕ}_{p}^{( b )} \\ 0 & otherwise\end{matrix}$$

is the index of the only output to which the p-th input is mapped, δ(t) is a Dirac delta, and τ≥0 is a delay that can be used to match the delay between the subbands in which the restriction is applied and the ones in which the restriction is not applied. The restriction forces the restricted MIMO blocks 904 of the selected subbands to map each input only to one of the outputs of the fourth example sound system 900. The restricted MIMO blocks 904 may be seen as a delay block 910 followed by a P:L demultiplexer 504 that maps each of the P inputs to one of the L outputs according to the selected indices

$$( {ϕ}_{0}^{( b )} , … , {ϕ}_{P - 1}^{( b )} ) .$$

In the example aspects of FIGS. 9 and 10, the fourth example sound system 900 has B=2 subbands, and the restriction is applied in the subband with index b=1. However, the present aspects are not so limited, and more than one subbands may be MIMO processed and/or restricted in other aspects.

In the subbands in which the restriction is not applied, each of the inputs is processed and mapped to every output, and therefore the MIMO blocks 204 may be designed such that ducking is achieved. In the subbands in which the restriction is applied, ducking in a subset of seats is not possible because each of the inputs of the restricted MIMO blocks 904 are only mapped to one of the outputs. However, the audio quality will be sufficient because the restricted MIMO blocks 904 do not introduce any distortion to the input signal (they only introduce a delay).

In comparison with the third example sound system 800 that implements subband MIMO-based ducking and can obtain neither any perceivable ducking nor sufficient audio quality at high frequencies, the fourth example sound system 900 that implements the restriction to the subbands that correspond to high frequencies does not get any ducking in high frequencies but maintains sufficient audio quality. Therefore, applying the restriction in the fourth example sound system 900 leads to improvements in the audio quality of the fourth example sound system 900 while keeping similar ducking capabilities as the third example sound system 800. Moreover, in the subbands in which the restriction is applied in the fourth example sound system 900, the required DSP resources are much lower, since only a delay operation needs to be performed.

For example, for a vehicle cabin with a typical distribution of speakers (e.g., three dash speakers, one speaker in each front and rear door, and two trunk speakers), MIMO processing may not properly control the sound field at frequencies above 3 kHz. In this case, a subband system may be defined with two subbands, where subband b=0 processes the signals below 3 kHz, and subband b=1 processes the signals above 3 kHz. The restriction is applied to subband b=1. Therefore, MIMO processing is used to process the frequency components below 3 kHz and is bypassed for higher frequencies. Accordingly, when ducking is desired in a certain subset of seats, the playback volume is reduced in those seats for frequencies below 3 kHz, while higher frequencies of the audio are not ducked at all.

In the frequency domain, the restriction applied by the restricted MIMO blocks 904 in the frequencies fin which ducking is not targeted may be expressed as:

$${H}_{p , l}^{( f )} = \{ \begin{matrix}{e}^{- j θ} & if l = {ϕ}_{p}^{( f )} \\ 0 & otherwise\end{matrix} \\ where {H}_{p , l}^{( f )}$$

is the frequency response of h_{p,l} (i.e., the processing block for the p-th input and l-th output in the restricted MIMO blocks 904),

$${ϕ}_{p}^{( f )}$$

is the index of the only output to which the p-th input is mapped at frequency f, and θ is a phase delay that can be used to match the delay between the frequencies in which the restriction is applied and the frequencies in which the restriction is not applied. The restriction forces the restricted MIMO blocks 904 to map each input only to one of the outputs of the restricted MIMO blocks 904 for the selected frequencies.

As compared to the scalar-based approaches, the fourth example sound system 900 provides better personalized ducking particularly at low and medium frequencies, while sufficient broadband audio quality is also achieved. Further, as compared to MIMO and subband MIMO-based systems that do not have restrictions, the fourth example sound system 900 that implements the restricted MIMO blocks 904 provides the same ducking level but also offers better audio quality at high frequencies. Further, as compared to subband MIMO-based systems that do not have restrictions, applying the restrictions in the restricted MIMO blocks 904 lowers DSP resource utilization (in terms of instruction per second and in terms of memory utilization).

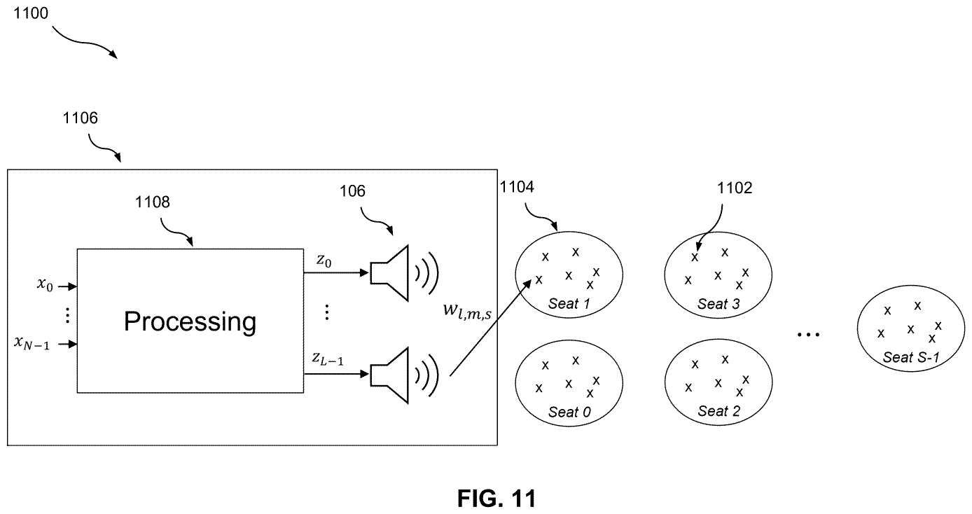

Referring to FIG. 11, a sound system performance evaluation system 1100 may be used to estimate the medium and low frequency ranges at which MIMO-based ducking can obtain both sufficient ducking levels and sufficient audio quality, and these frequency ranges may depend on the number of speakers 106 and their positions, spatial aliasing properties, the acoustic environment in a vehicle, etc., although similar principles can apply to other environments. As described below, the sound system performance evaluation system 1100 may be used to predict the Mean Energy (ME) and the Normalized Mean Square Error (NMSE) that a MIMO system would produce, and therefore, to obtain the information required to estimate the frequency ranges in which a MIMO system would obtain sufficient ducking levels and sufficient audio quality.

In a tuning stage, a set of M microphones 1102 are placed in each of S seats 1104 (or sound zones) of a vehicle, and the Room Impulse Responses (RIRs) w_{l,m,s} between every speaker l and every microphone m in every seat s are measured (for example, using the sine sweep technique). Once the measurements of w_{l,m,s} are obtained, the microphones can be removed from the vehicle. The RIRs w_{l,m,s} may be used to evaluate the performance of any signal processing chain that a sound system 1106 may include. In FIG. 11, the sound system 1106 includes a processing block 1108 which includes all the processing subblocks that the sound system 1106 implements. For example, the processing block 1108 may include the pre-processing block 502 and the demultiplexer 504 as in the first example sound system 500, may include the pre-processing block 502 and the MIMO processing system 100 as in the second example sound system 700, may include the pre-processing block 502 and the subband MIMO processing system 200 as in the third example sound system 800, or may include the pre-processing block 502 and the subband MIMO processing variation system 902 as in the fourth example sound system 900.

Using the measured RIRs w_{l,m,s}, the sound field that is generated by the sound system 1106 is estimated in the positions in which the microphones 1102 are placed and for a particular set of signals zₗ that are fed to the speakers 106. For example, the frequency response of the sound field produced in the m-th microphone of the s-th seat may be expressed as:

$${X}_{m , s} ( f ) = {\sum }_{l = 0}^{L - 1} {W}_{l , m , s} ( f ) \cdot {Z}_{l} ( f )$$

where W_{l,m,s}(f) is the frequency response of w_{l,m,s}, and Zₗ(f) is the frequency response of zₗ. Using X_{m,s}(f), the ME generated in the s-th seat by the sound system 1106 at frequency f may be estimated as:

$${E}_{s} ( f ) = \frac{1}{M} {\sum }_{m = 0}^{M - 1} {\vert {X}_{m , s} ( f ) \vert}^{2}$$

and the NMSE in the s-th seat with respect to a target response at frequency f may be estimated as:

$${ϵ}_{s} ( f ) = \frac{1}{M} {\sum }_{m = 0}^{M - 1} \frac{{\vert {X}_{m , s} ( f ) - {D}_{m , s} ( f ) \vert}^{2}}{{\vert {D}_{m , s} ( f ) \vert}^{2}}$$

where D_{m,s}(f) is the target frequency response desired to achieve in the m-th microphone of the s-th seat. The NMSE indicates the level of deviation of the sound field produced by the sound system 1106 with respect to a target response, and is an indicator of the audio quality of the sound system 1106.

The ME and NMSE may be used to evaluate the performance of a ducking mechanism of the sound system 1106. Specifically, for example, when the sound system 1106 is implementing personalized ducking, the sound system 1106 may be required to obtain at least 6 dB lower ME in the subset of seats in which the audio needs to be ducked, as compared to the other seats in which ducking is not targeted. Further, when the sound system 1106 is implementing personalized ducking, the sound system 1106 may be required to obtain NMSE values lower than −6 dB in those seats in which audio ducking is not targeted, such that the audio quality is sufficient in these seats while ducking is being targeted in the other seats.

In these aspects, the NMSE depends on the selection of the target response D_{m,s}(f), and the target response D_{m,s}(f) may be selected as the response that would be produced by the sound system 1106 without any ducking mechanism (e.g., the first example sound system 500). This selection assures that obtaining low NMSE values guarantees that the audio quality of the sound system 1106 is not significantly worsened by the ducking mechanism. Further, since the ME and the NMSE are a function of frequency, these metrics allow for evaluating the level of personalized ducking and the audio quality in different frequency ranges.

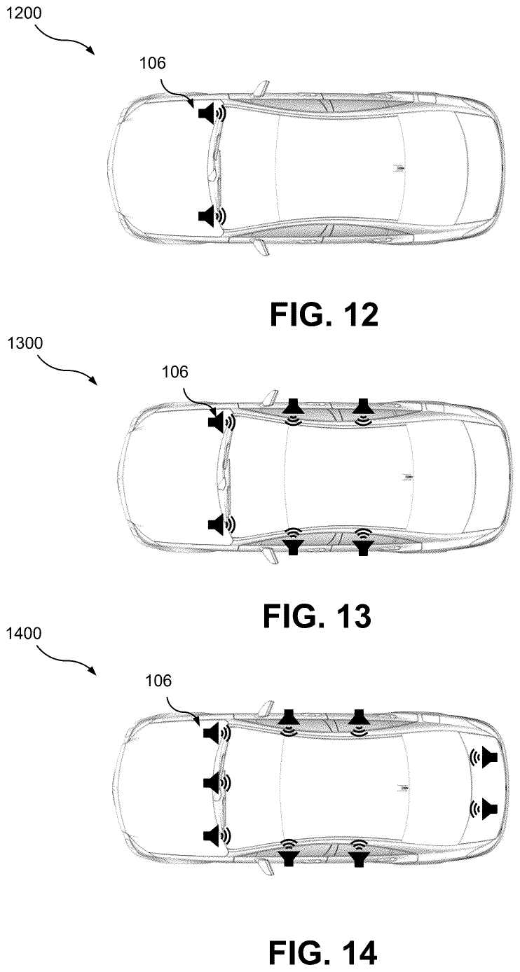

Referring to FIGS. 12-14, different example vehicle speaker layouts 1200, 1300, 1400 may result in different frequency ranges at which MIMO-based ducking can obtain both sufficient ducking levels and sufficient audio quality. For example, referring to FIG. 12, in a first example vehicle speaker layout 1200 with two speakers 106 including a left dash speaker and a right dash speaker, sufficient MIMO performance may be obtained for frequencies up to 300 Hz. Referring to FIG. 13, in a second example vehicle speaker layout 1300 with six speakers 106 including a left dash speaker, a right dash speaker, a front left door speaker, a front right door speaker, a rear left door speaker, and a rear right door speaker, sufficient MIMO performance may be obtained for frequencies up to 1 kHZ. Referring to FIG. 14, in a third example vehicle speaker layout 1400 with nine speakers 106 including a left dash speaker, a right dash speaker, a center dash speaker, a front left door speaker, a front right door speaker, a rear left door speaker, a rear right door speaker, a trunk left speaker, and a trunk right speaker, sufficient MIMO performance may be obtained for frequencies up to 3 kHZ.

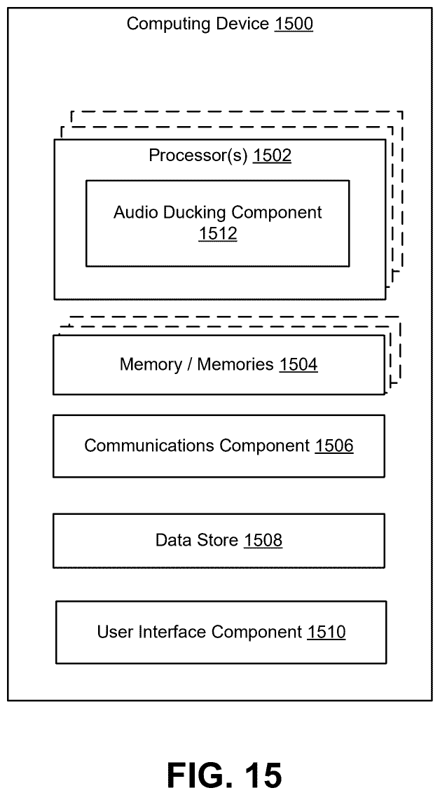

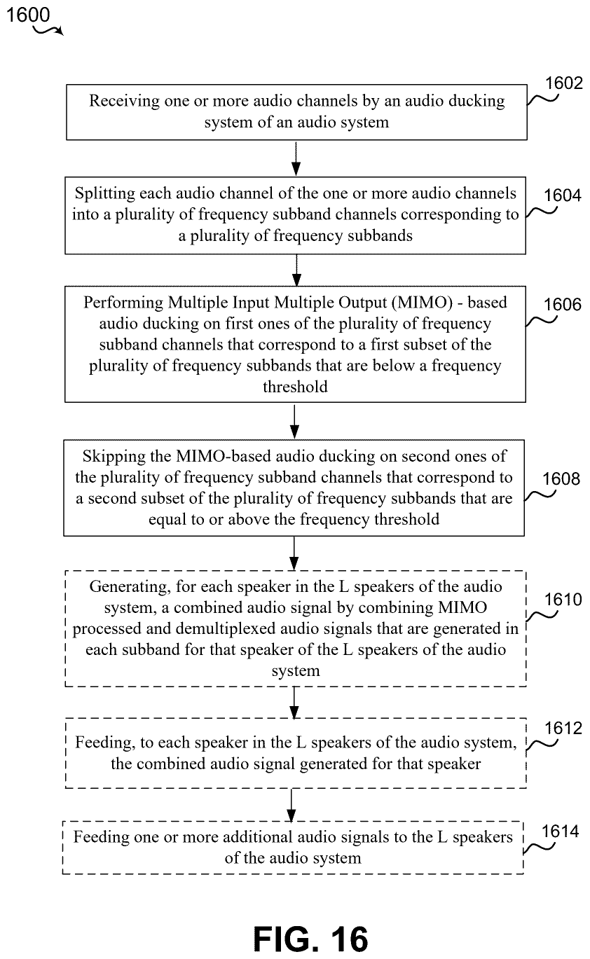

Referring to FIG. 15, an example block diagram provides details of computing components in a computing device 1500 that may implement all or a portion of an audio system or any other component described with reference to FIGS. 1-14 above or with reference to FIG. 16 below. The computing device 1500 includes one or more processors 1502 which, individually, as a subgroup, or in combination, may be configured to execute or implement software, hardware, and/or firmware modules that perform any audio ducking functionality described above with reference to FIGS. 1-14 above or with reference to FIG. 16 below.

As used herein, a processor, at least one processor, and/or one or more processors, individually, as a subgroup, or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 1502 may be a micro-controller and/or may include a single or multiple set of processors or multi-core processors. Moreover, the one or more processors 1502 may be implemented as an integrated processing system and/or a distributed processing system.

The computing device 1500 may further include one or more memories 1504, such as for storing local versions of applications being executed by the one or more processors 1502, related instructions, parameters, etc. The one or more memories 1504 may include a type of memory usable by a computer, such as random access memory (RAM), read only memory (ROM), tapes, magnetic discs, optical discs, volatile memory, non-volatile memory, and any combination thereof. Additionally, the one or more processors 1502 and the one or more memories 1504 may include and execute an operating system executing on the one or more processors 1502, individually, as a subgroup, or in combination, one or more applications, display drivers, etc., and/or other components of the computing device 1500.

As used herein, a memory, at least one memory, and/or one or more memories, individually, as a subgroup, or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually, as a subgroup, or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 1500 may include a communications component 1506 that provides for establishing and maintaining communications with one or more other devices, parties, entities, etc., utilizing hardware, software, and services. The communications component 1506 may carry communications between components on the computing device 1500, as well as between the computing device 1500 and external devices, such as devices located across a communications network and/or devices serially or locally connected to the computing device 1500. For example, the communications component 1506 may include one or more buses, and may further include transmit chain components and receive chain components associated with a wireless or wired transmitter and receiver, respectively, operable for interfacing with external devices.

Additionally, the computing device 1500 may include a data store 1508, which can be any suitable combination of hardware and/or software, that provides for mass storage of information, databases, and programs. For example, the data store 1508 may be or may include a data repository for applications and/or related parameters not currently being executed by the one or more processors 1502, individually, as a subgroup, or in combination. In addition, the data store 1508 may be a data repository for an operating system, application, display driver, etc., executing on the one or more processors 1502, individually, as a subgroup, or in combination, and/or one or more other components of the computing device 1500.

The computing device 1500 may also include a user interface component 1510 operable to receive inputs from a user of the computing device 1500 and further operable to generate outputs for presentation to the user (e.g., via a display interface to a display device). The user interface component 1510 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 1510 may include one or more output devices, including but not limited to a display interface, a speaker, a haptic feedback mechanism, a printer, any other mechanism capable of presenting an output to a user, or any combination thereof.

Referring to FIG. 16, in operation for audio ducking functionality, computing device 1500 may implement at least a portion of one or more components in FIGS. 1-15 above, such as all or at least a portion of an audio system or any other component configured for audio ducking functionality. In this case, the computing device 1500 may perform method 1600 such as via execution of an audio ducking component 1512 by one or more processors 1502 individually, as a subgroup, or in combination, and/or one or more memories 1504 individually, as a subgroup, or in combination. Specifically, computing device 1500 may be configured to perform method 1600 for performing an aspect of audio ducking functionality, as described herein.

At block 1602 the method 1600 includes receiving one or more audio channels by an audio ducking system of an audio system. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for receiving one or more audio channels by an audio ducking system of an audio system.

For example, referring to FIG. 9, the subband MIMO processing variation system 902 in the fourth example sound system 900 may receive outputs yₚ of the pre-processing block 502 representing one or more audio channels.

At block 1604 the method 1600 includes splitting each audio channel of the one or more audio channels into a plurality of frequency subband channels corresponding to a plurality of frequency subbands. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for splitting each audio channel of the one or more audio channels into a plurality of frequency subband channels corresponding to a plurality of frequency subbands.

For example, the subband MIMO processing variation system 902 in the fourth example sound system 900 may split each yₚ into B subband components

$${y}_{p}^{( b )}$$

using band splitters 202.

At block 1606 the method 1600 includes performing Multiple Input Multiple Output (MIMO)—based audio ducking on first ones of the plurality of frequency subband channels that correspond to a first subset of the plurality of frequency subbands that are below a frequency threshold. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for performing Multiple Input Multiple Output (MIMO)—based audio ducking on first ones of the plurality of frequency subband channels that correspond to a first subset of the plurality of frequency subbands that are below a frequency threshold.

For example, the subband MIMO processing variation system 902 in the fourth example sound system 900 may perform MIMO-based audio ducking for relatively low/medium frequencies by using the MIMO block 204 for subband MIMO processing in subband 0.

At block 1608 the method 1600 includes skipping the MIMO-based audio ducking on second ones of the plurality of frequency subband channels that correspond to a second subset of the plurality of frequency subbands that are equal to or above the frequency threshold. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for skipping the MIMO-based audio ducking on second ones of the plurality of frequency subband channels that correspond to a second subset of the plurality of frequency subbands that are equal to or above the frequency threshold.

For example, the subband MIMO processing variation system 902 in the fourth example sound system 900 may apply a restriction to skip MIMO-based audio ducking for relatively high frequencies in subband 1.

In some implementations, the one or more audio channels may comprise P audio channels, the plurality of frequency subbands may comprise B frequency subbands, and the audio system may comprise L speakers.

In some implementations, for each subband in the first subset of the B frequency subbands that are below the frequency threshold, performing MIMO-based audio ducking at block 1606 may comprise applying a P by L MIMO matrix to P frequency subband channels that correspond to that subband to generate L audio signals comprising one audio signal for each one of the L speakers of the audio system.

In some implementations, for each subband in the second subset of the B frequency subbands that are equal to or above the frequency threshold, skipping the MIMO-based audio ducking at block 1608 may comprise applying a P by L demultiplexer to P subband channels that correspond to that subband to generate L audio signals comprising one audio signal for each one of the L speakers of the audio system.

At optional block 1610 the method 1600 may include generating, for each speaker in the L speakers of the audio system, a combined audio signal by combining MIMO processed and demultiplexed audio signals that are generated in each subband for that speaker of the L speakers of the audio system. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for generating, for each speaker in the L speakers of the audio system, a combined audio signal by combining MIMO processed and demultiplexed audio signals that are generated in each subband for that speaker of the L speakers of the audio system.

For example, the subband MIMO processing variation system 902 in the fourth example sound system 900 may use band combiners 206 to generate, for each speaker in the L speakers 106, a combined audio signal by combining MIMO processed and demultiplexed audio signals that are generated in each subband for that speaker of the L speakers 106.

At optional block 1612 the method 1600 may include feeding, to each speaker in the L speakers of the audio system, the combined audio signal generated for that speaker. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for feeding, to each speaker in the L speakers of the audio system, the combined audio signal generated for that speaker.

For example, the subband MIMO processing variation system 902 in the fourth example sound system 900 may feed, to each speaker in the L speakers 106, the combined audio signal generated by the band combiners 206 for that speaker.

At optional block 1614 the method 1600 may include feeding one or more additional audio signals to the L speakers of the audio system. For example, in an aspect, computing device 1500, one or more processors 1502 individually, as a subgroup, or in combination, one or more memories 1504 individually, as a subgroup, or in combination, and/or audio ducking component 1512 may be configured to or may comprise means for feeding one or more additional audio signals to the L speakers of the audio system.

For example, the fourth example sound system 900 may feed one or more additional audio signals 906 to the L speakers 106. For example, one or more additional signals z′ₗ may be fed to the speakers 106 of the fourth example sound system 900. For example, in addition to z₀, an additional audio signal z′₀ may be fed to the first speaker; in addition to z₁, an additional audio signal z′₁ may be fed to the second speaker; etc.

In some optional implementations, the one or more additional audio signals 906 may comprise a notification, an instruction, or an audio conversation.

In some optional implementations, the MIMO-based audio ducking is configured to duck the one or more audio channels as received in a first subset of seats in an acoustic space of the audio system.

In some optional implementations, the one or more additional audio signals are configured to play on top of the one or more audio channels that are ducked as received in the first subset of seats in the acoustic space of the audio system.

In some optional implementations, the one or more additional audio signals are ducked as received in a second subset of seats in the acoustic space of the audio system.

In some optional implementations, the frequency threshold is determined by measuring Room Impulse Responses (RIRs) between one or more speakers of the audio system and one or more positions within seats in the acoustic space of the audio system.

Another example aspect includes an apparatus comprising one or more memories storing instructions, and one or more processors coupled with the one or more memories. The one or more processors, individually, as a subgroup, or in combination, are configured to execute the instructions to perform any audio ducking functionality described herein.

Another example aspect includes an apparatus comprising means for performing any audio ducking functionality described herein.

Another example aspect includes one or more computer-readable media having instructions stored thereon, wherein the instructions are executable by one or more processors, individually, as a subgroup, or in combination, to perform any audio ducking functionality described herein.

Another example aspects includes a system comprising an audio ducking system of an audio system, the system comprising: one or more band splitters configured to split each audio channel of one or more audio channels into a plurality of frequency subband channels corresponding to a plurality of frequency subbands; and one or more Multiple Input Multiple Output (MIMO)—based audio ducking components configured to perform MIMO-based audio ducking on first ones of the plurality of frequency subband channels that correspond to a first subset of the plurality of frequency subbands that are below a frequency threshold, wherein the system is configured to skip MIMO-based audio ducking on second ones of the plurality of frequency subband channels that correspond to a second subset of the plurality of frequency subbands that are equal to or above the frequency threshold.

In some optional implementations, the one or more audio channels may comprise P audio channels, wherein the plurality of frequency subbands comprise B frequency subbands, wherein the audio system comprises L speakers.

In some optional implementations, for each subband in the first subset of the B frequency subbands that are below the frequency threshold, a corresponding MIMO-based audio ducking component is configured to apply a P by L MIMO matrix to P frequency subband channels that correspond to that subband to generate L audio signals comprising one audio signal for each one of the L speakers of the audio system.

In some optional implementations, the system may further comprise one or more P by L demultiplexers, wherein, for each subband in the second subset of the B frequency subbands that are equal to or above the frequency threshold, a corresponding P by L demultiplexer is configured to demultiplex P subband channels that correspond to that subband to generate L audio signals comprising one audio signal for each one of the L speakers of the audio system.

In some optional implementations, the system may further comprise L band combiners configured to: generate, for each speaker in the L speakers of the audio system, a combined audio signal by combining MIMO processed and demultiplexed audio signals that are generated in each subband for that speaker of the L speakers of the audio system; and feed, to each speaker in the L speakers of the audio system, the combined audio signal generated for that speaker.

In some optional implementations, the audio system is further configured to feed one or more additional audio signals to the L speakers.

In some optional implementations, the one or more additional audio signals comprise a navigation instruction for a vehicle.

In some optional implementations, the one or more MIMO-based audio ducking components are configured to duck the one or more audio channels as received in a first subset of seats in an acoustic space of the audio system, wherein the audio system is configured to play the one or more additional audio signals on top of the one or more audio channels that are ducked as received in the first subset of seats in the acoustic space of the audio system.

In some optional implementations, the audio system is configured to duck the one or more additional audio signals as received in a second subset of seats in an acoustic space of the audio system.

Additionally, some further example aspects are provided below in the form of one or more clauses.

Clause 1. A method comprising: receiving one or more audio channels by an audio ducking system of an audio system; splitting each audio channel of the one or more audio channels into a plurality of frequency subband channels corresponding to a plurality of frequency subbands; performing Multiple Input Multiple Output (MIMO)—based audio ducking on first ones of the plurality of frequency subband channels that correspond to a first subset of the plurality of frequency subbands that are below a frequency threshold; and skipping the MIMO-based audio ducking on second ones of the plurality of frequency subband channels that correspond to a second subset of the plurality of frequency subbands that are equal to or above the frequency threshold.

Clause 2. The method of clause 1, wherein the one or more audio channels comprise P audio channels, wherein the plurality of frequency subbands comprise B frequency subbands, wherein the audio system comprises L speakers.

Clause 3. The method of clause 2, wherein, for each subband in the first subset of the B frequency subbands that are below the frequency threshold, performing the MIMO-based audio ducking comprises applying a P by L MIMO matrix to P frequency subband channels that correspond to that subband to generate L audio signals comprising one audio signal for each one of the L speakers of the audio system.

Clause 4. The method of clause 2 or 3, wherein, for each subband in the second subset of the B frequency subbands that are equal to or above the frequency threshold, skipping the MIMO-based audio ducking comprises applying a P by L demultiplexer to P subband channels that correspond to that subband to generate L audio signals comprising one audio signal for each one of the L speakers of the audio system.

Clause 5. The method of any one or clauses 2 to 4, further comprising: generating, for each speaker in the L speakers of the audio system, a combined audio signal by combining MIMO processed and demultiplexed audio signals that are generated in each subband for that speaker of the L speakers of the audio system; and feeding, to each speaker in the L speakers of the audio system, the combined audio signal generated for that speaker.

Clause 6. The method of any one of clauses 2 to 5, further comprising feeding one or more additional audio signals to the L speakers of the audio system.

Clause 7. The method of clause 6, wherein the one or more additional audio signals comprise a notification, an instruction, or an audio conversation.

Clause 8. The method of clause 6 or 7, wherein the MIMO-based audio ducking is configured to duck the one or more audio channels as received in a first subset of seats in an acoustic space of the audio system.

Clause 9. The method of any one of clauses 6 to 8, wherein the one or more additional audio signals are configured to play on top of the one or more audio channels that are ducked as received in the first subset of seats in the acoustic space of the audio system.

Clause 10. The method of any one of clauses 6 to 9, wherein the one or more additional audio signals are ducked as received in a second subset of seats in the acoustic space of the audio system.

Clause 11. The method of any one of the preceding clauses, wherein the frequency threshold is determined by measuring Room Impulse Responses (RIRs) between one or more speakers of the audio system and one or more positions in an acoustic space of the audio system.

Clause 12. A system comprising an audio ducking system of an audio system, the system comprising: one or more band splitters configured to split each audio channel of one or more audio channels into a plurality of frequency subband channels corresponding to a plurality of frequency subbands; and one or more Multiple Input Multiple Output (MIMO)—based audio ducking components configured to perform MIMO-based audio ducking on first ones of the plurality of frequency subband channels that correspond to a first subset of the plurality of frequency subbands that are below a frequency threshold, wherein the system is configured to skip the MIMO-based audio ducking on second ones of the plurality of frequency subband channels that correspond to a second subset of the plurality of frequency subbands that are equal to or above the frequency threshold.

Clause 13. The system of clause 12, wherein the one or more audio channels comprise P audio channels, wherein the plurality of frequency subbands comprise B frequency subbands, wherein the audio system comprises L speakers.

Clause 14. The system of clause 13, wherein, for each subband in the first subset of the B frequency subbands that are below the frequency threshold, a corresponding MIMO-based audio ducking component is configured to apply a P by L MIMO matrix to P frequency subband channels that correspond to that subband to generate L audio signals comprising one audio signal for each one of the L speakers of the audio system.

Clause 15. The system of clause 13 or 14, further comprising one or more P by L demultiplexers, wherein, for each subband in the second subset of the B frequency subbands that are equal to or above the frequency threshold, a corresponding P by L demultiplexer is configured to demultiplex P subband channels that correspond to that subband to generate L audio signals comprising one audio signal for each one of the L speakers of the audio system.

Clause 16. The system of any one of clauses 13 to 15, further comprising L band combiners configured to: generate, for each speaker in the L speakers of the audio system, a combined audio signal by combining MIMO processed and demultiplexed audio signals that are generated in each subband for that speaker of the L speakers of the audio system; and feed, to each speaker in the L speakers of the audio system, the combined audio signal generated for that speaker.

Clause 17. The system of any one of clauses 13 to 16, wherein the audio system is further configured to feed one or more additional audio signals to the L speakers.

Clause 18. The system of clause 17, wherein the one or more additional audio signals comprise a notification, an instruction, or an audio conversation.

Clause 19. The system of clause 17 or 18, wherein the one or more MIMO-based audio ducking components are configured to duck the one or more audio channels as received in a first subset of seats in an acoustic space of the audio system, wherein the audio system is configured to play the one or more additional audio signals on top of the one or more audio channels that are ducked as received in the first subset in the acoustic space of the audio system.

Clause 20. The system of any one of clauses 17 to 19, wherein the audio system is configured to duck the one or more additional audio signals as received in a second subset of seats in the acoustic space of the audio system.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
receiving one or more audio channels by an audio ducking system of an audio system;
splitting each audio channel of the one or more audio channels into a plurality of frequency subband channels corresponding to a plurality of frequency subbands;
performing Multiple Input Multiple Output (MIMO)—based audio ducking on first ones of the plurality of frequency subband channels that correspond to a first subset of the plurality of frequency subbands that are below a frequency threshold; and
skipping the MIMO-based audio ducking on second ones of the plurality of frequency subband channels that correspond to a second subset of the plurality of frequency subbands that are equal to or above the frequency threshold.

2. The method of claim 1, wherein the one or more audio channels comprise P audio channels, wherein the plurality of frequency subbands comprise B frequency subbands, wherein the audio system comprises L speakers.

3. The method of claim 2, wherein, for each subband in the first subset of the B frequency subbands that are below the frequency threshold, performing the MIMO-based audio ducking comprises applying a P by L MIMO matrix to P frequency subband channels that correspond to that subband to generate L audio signals comprising one audio signal for each one of the L speakers of the audio system.

4. The method of claim 3, wherein, for each subband in the second subset of the B frequency subbands that are equal to or above the frequency threshold, skipping the MIMO-based audio ducking comprises applying a P by L demultiplexer to P subband channels that correspond to that subband to generate L audio signals comprising one audio signal for each one of the L speakers of the audio system.

5. The method of claim 4, further comprising:
generating, for each speaker in the L speakers of the audio system, a combined audio signal by combining MIMO processed and demultiplexed audio signals that are generated in each subband for that speaker of the L speakers of the audio system; and
feeding, to each speaker in the L speakers of the audio system, the combined audio signal generated for that speaker.

6. The method of claim 5, further comprising feeding one or more additional audio signals to the L speakers of the audio system.

7. The method of claim 6, wherein the one or more additional audio signals comprise a notification, an instruction, or an audio conversation.

8. The method of claim 6, wherein the MIMO-based audio ducking is configured to duck the one or more audio channels as received in a first subset of seats in an acoustic space of the audio system.

9. The method of claim 8, wherein the one or more additional audio signals are configured to play on top of the one or more audio channels that are ducked as received in the first subset of seats in the acoustic space of the audio system.

10. The method of claim 8, wherein the one or more additional audio signals are ducked as received in a second subset of seats in the acoustic space of the audio system.

11. The method of claim 1, wherein the frequency threshold is determined by measuring Room Impulse Responses (RIRs) between one or more speakers of the audio system and one or more positions in an acoustic space of the audio system.

12. A system comprising an audio ducking system of an audio system, the system comprising:
one or more band splitters configured to split each audio channel of one or more audio channels into a plurality of frequency subband channels corresponding to a plurality of frequency subbands; and
one or more Multiple Input Multiple Output (MIMO)—based audio ducking components configured to perform MIMO-based audio ducking on first ones of the plurality of frequency subband channels that correspond to a first subset of the plurality of frequency subbands that are below a frequency threshold, wherein the system is configured to skip the MIMO-based audio ducking on second ones of the plurality of frequency subband channels that correspond to a second subset of the plurality of frequency subbands that are equal to or above the frequency threshold.

13. The system of claim 12, wherein the one or more audio channels comprise P audio channels, wherein the plurality of frequency subbands comprise B frequency subbands, wherein the audio system comprises L speakers.

14. The system of claim 13, wherein, for each subband in the first subset of the B frequency subbands that are below the frequency threshold, a corresponding MIMO-based audio ducking component is configured to apply a P by L MIMO matrix to P frequency subband channels that correspond to that subband to generate L audio signals comprising one audio signal for each one of the L speakers of the audio system.

15. The system of claim 14, further comprising one or more P by L demultiplexers, wherein, for each subband in the second subset of the B frequency subbands that are equal to or above the frequency threshold, a corresponding P by L demultiplexer is configured to demultiplex P subband channels that correspond to that subband to generate L audio signals comprising one audio signal for each one of the L speakers of the audio system.

16. The system of claim 15, further comprising L band combiners configured to:
generate, for each speaker in the L speakers of the audio system, a combined audio signal by combining MIMO processed and demultiplexed audio signals that are generated in each subband for that speaker of the L speakers of the audio system; and
feed, to each speaker in the L speakers of the audio system, the combined audio signal generated for that speaker.

17. The system of claim 16, wherein the audio system is further configured to feed one or more additional audio signals to the L speakers.

18. The system of claim 17, wherein the one or more additional audio signals comprise a notification, an instruction, or an audio conversation.

19. The system of claim 17, wherein the one or more MIMO-based audio ducking components are configured to duck the one or more audio channels as received in a first subset of seats in an acoustic space of the audio system, wherein the audio system is configured to play the one or more additional audio signals on top of the one or more audio channels that are ducked as received in the first subset in the acoustic space of the audio system.

20. The system of claim 19, wherein the audio system is configured to duck the one or more additional audio signals as received in a second subset of seats in the acoustic space of the audio system.
